(19) United States
(12) Patent Application Publication
(10) Pub. No.: US 2025/0278845 A1
(43) Pub. Date: Sep. 4, 2025

(54) ANATOMY-BASED MEDICAL-IMAGE REGISTRATION

(71) Applicant: AI Analysis, Inc., Bellevue, WA (US)

(72) Inventors: Julia Patriarche, Bellevue, WA (US); Robert W. Bergstrom, Bainbridge Island, WA (US)

(73) Assignee: AI Analysis, Inc., Bellevue, WA (US)

(21) Appl. No.: 19/065,450

(22) Filed: Feb. 27, 2025

Related U.S. Application Data
(60) Provisional application No. 63/559,561, filed on Feb. 29, 2024.

(51) Int. Cl. G06T 7/33

(52) U.S. Cl. CPC G06T 7/337; G06T 2200/04; G06T 2207/20081; G06T 2207/30004

(57) ABSTRACT

The current document is directed to methods and systems that carry out deformable-image registration on two or more medical images using machine-learning and anatomical constraints. In one implementation, a first machine-learning system is used to generate a set of anatomical features within a first medical image. A second machine-learning system is used to add anatomical constraints for a selected anatomical feature to an initial map that is then updated, by a third machine-learning system, to generate a current map or transform that can be used to register a second medical image to the first medical image. The current map or transform is iteratively updated, using additional anatomical features, until improvement in the current map or transform falls below a threshold value.

### CROSS-REFERENCE TO RELATED APPLICATION

This application claims the benefit of Provisional Application No. 63/559,561, filed Feb. 29, 2025.

### TECHNICAL FIELD

The current document is directed to registration of medical images and, in particular, to medical-image-registration methods and systems that carry out deformable-image registration on two or more medical images using machine-learning and anatomical constraints.

### BACKGROUND

Methods and systems that process medical images have been employed for many years. Processing of medical images is carried out for a variety of different reasons, including computational sharpening and focusing of medical images, automated information extraction from medical images, automated interpretation of medical images, automated diagnosis based, in part, on medical images, treatment planning based, in part, on medical images, and control of automated therapeutic systems based, in part, on medical images. In many cases, two or more medical images taken at different time points are used to follow the progression of pathologies and to detect newly arising pathologies and conditions.

Registering two or more images so that corresponding features, areas, or volumes in each of the two or more images can be identified and compared is a primary subtask associated with processing medical images. In essence, registration of two or more images establishes a common coordinate system for the two or more images so that corresponding pixels or voxels are similarly indexed by the common coordinate system. The registration process can also be thought of as generating a map, or transform, that transforms the coordinates of one or more images with respect to a reference image so that features common to the two or more images have identical or similar coordinate-based positions within each of the images. There are several different types of transforms, including rigid transforms that involve applying the same transformation across an entire image and deformable transforms that allow for location-specific transformations within images. Generation of a deformable transform involves many more degrees of freedom than generation of a rigid transform. As a result, the computational overhead for a deformable transform is much greater than for a rigid transform. Furthermore, many different possible deformable transforms can be generated to produce the same or a similar transform-quality-metric value. This leads to a need to choose a transform from many different possible deformable transforms for registration of any particular set of images. These problems with deformable transforms have resulted in relatively low-quality deformable-image registration produced by many automated image-registration systems. Improvements to the methods and systems used to carry out deformable-transformation-based medical-image registration are currently sought by researchers, developers of medical-imaging systems, and users of medical-imaging systems.

### SUMMARY

The current document is directed to methods and systems that carry out deformable-image registration on two or more medical images using machine-learning and anatomical constraints. In one implementation, a first machine-learning system is used to generate a set of anatomical features within a first medical image. A second machine-learning system is used to add anatomical constraints for a selected anatomical feature to an initial map that is then updated, by a third machine-learning system, to generate a current map or transform that can be used to register a second medical image to the first medical image. The current map or transform is iteratively updated, using additional anatomical features, until improvement in the current map or transform falls below a threshold value.

### BRIEF DESCRIPTION OF THE DRAWINGS

FIG. 1 illustrates two images that include common features.

FIG. 2 illustrates transformations that can be used for rigid registration of the two images shown in FIG. 1.

FIG. 3 illustrates a coordinate transformation used to implement rigid image registration of two three-dimensional images.

FIG. 4 shows two images with similar features.

FIG. 5 shows the positions of the three features of the second image in FIG. 4 superimposed onto the first image 402.

FIG. 6 illustrates different types of deformable-image-registration transforms.

FIG. 7 illustrates a machine-learning system, MLS_1, used in a described implementation of the currently disclosed improved deformable image-registration methods and systems.

FIG. 8 illustrates example uses of the map generated by the currently disclosed deformable image-registration methods.

FIG. 9 illustrates training of the machine-learning system MLS_1 shown in FIG. 7.

FIG. 10 illustrates a second machine-learning system, MLS_2, employed in the currently discussed implementation of the currently disclosed deformable image-registration methods and systems.

FIG. 11 illustrates a third machine-learning system, MLS_3, employed in the currently discussed implementation of the currently disclosed deformable image-registration methods and systems.

FIG. 12 provides a control-flow diagram that illustrates one implementation of the currently disclosed deformable image-registration process.

FIG. 13 provides a flow-control diagram for the routine “constrained registration,” called in step 1208 of FIG. 12.

### DETAILED DESCRIPTION

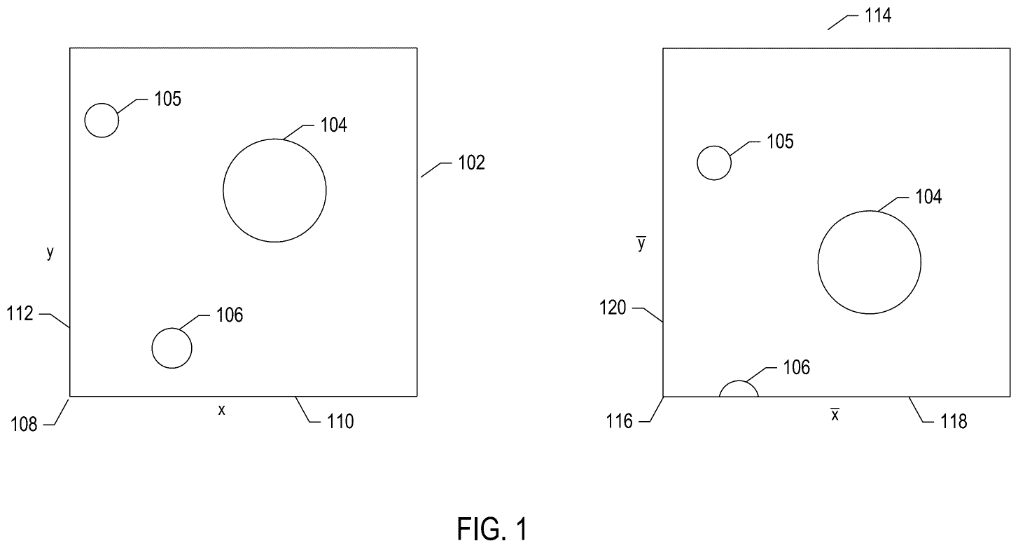

FIG. 1 illustrates two images that include common features. The first image 102 includes three circular features 104-106. The first image consists of small pixels that are indexed by a coordinate system with an origin 108 at the left lower corner of the image 102 and two orthogonal axes, including an x axis 110 and a y axis 112. Similarly, the second image 114 also consists of small pixels that are indexed by a coordinate system with origin 116, an x̅ axis 118, and a y̅ axis 120. The second image contains all or a portion of the three circular features 104-106 included in the first image. However, as can be seen by cursory visual inspection, the positions of the three circular features within the second image differ from the positions of the three circular features in the first image. The second image may have been acquired from a different angle and/or position from the angle and/or position from which the first image was acquired, the values of imagining-system parameters used to acquire the first image may have changed prior to acquisition of the second image, and/or the shapes and sizes of the imaged features may have changed during the time interval between acquisition of the first image and acquisition of the second image.

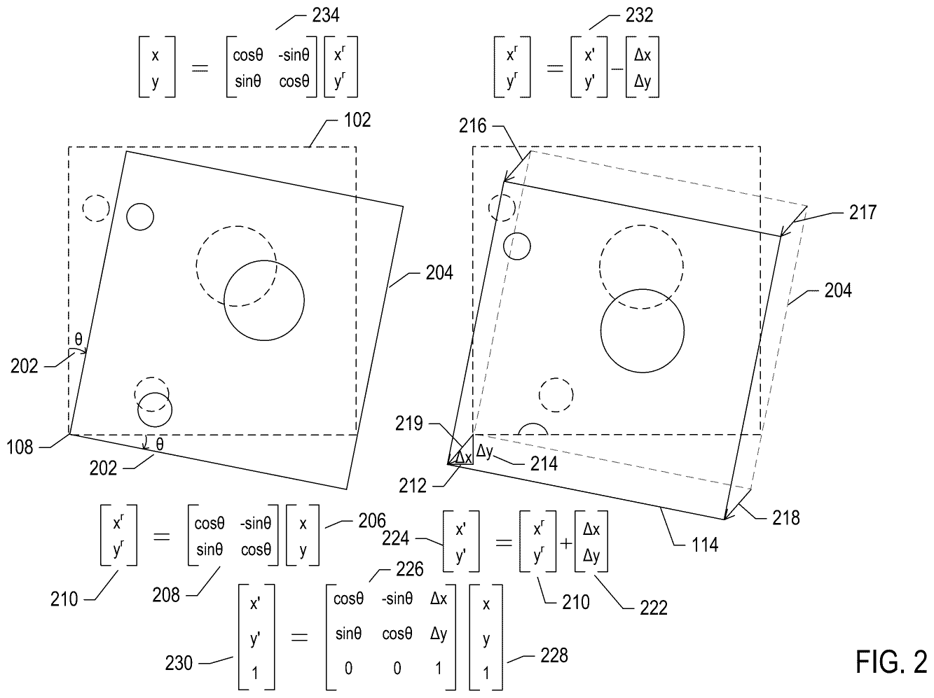

FIG. 2 illustrates transformations that can be used for rigid registration of the two images shown in FIG. 1. A first transform can be used to transform first-image coordinates to corresponding coordinates of second-image image features with respect to the coordinate system of the first image. In a first step of the transformation, the first image 102 is rotated by an angle θ 202 about the origin 108 to produce a rotated image 204. The coordinates of a point (x, y) in the original image are transformed to new, rotated coordinates (x′, y″) in the coordinate system of the first image by multiplying the coordinate vector 207 by the rotation matrix 208 to produce the rotated coordinate vector 210. In a second step of the transformation, the rotated image 204 is translated by Δx in the x-coordinate 212 and Δy in the y-coordinate 214 to produce the second image 114 discussed above with reference to FIG. 1. In the example shown in FIG. 2, both Δx and Δy have negative values, resulting in a translation downward and to the left, as represented in FIG. 2 by arrows 216-219 representing translations of the corner points of the rotated image 204 to corresponding corner points of the translated image 220. The coordinates of a point (x′, y″) of the rotated image in the coordinate system of the first image are transformed into final coordinates (x′, y′) of the second image 114 in the coordinate system of the first image by adding a translation vector 222 the rotated coordinate vector 210 to produce the second-image coordinate vector 224. The rotation and translation can be combined in a single transformation matrix 226 that can be used to transform quasi-homogeneous first-image coordinates (x, y, 1) 228 to corresponding translated and rotated coordinates (x′, y′, 1) 230. The inverse operation of translating second-image coordinates back to first-image coordinates can be carried out with the inverse operations shown in expressions 232 and 234. Thus, the forward and inverse coordinate transformations can be used to perform a rigid image-registration process that registers the first image 102 in FIG. 1 to the second image 114 in FIG. 1 or that registers second image 114 in FIG. 1 to the first image 102 in FIG. 1. This is an example of a rigid image-registration process because the transformation processes are applied identically to each pixel in an image that is registered to another image. As a result, the lengths, shapes, and areas of features are preserved in the transformation. Note that only that portion of the two images common to both images is registered.

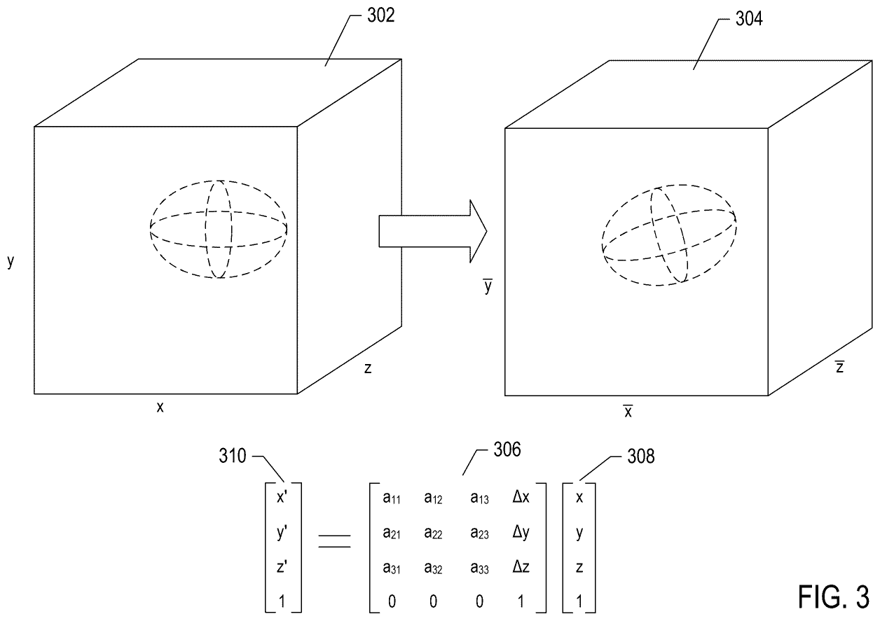

FIG. 3 illustrates a coordinate transformation used to implement rigid image registration of two three-dimensional images. Each of the first 302 and second 304 three-dimensional images comprises a set of voxels indexed by three Euclidean coordinate axes. In this case, a 4×4 transformation matrix 306 is used to transform first-image coordinates 308 to second-image coordinates 310. Additional types of linear transformations can incorporate skew and projection transformations. In these cases, the 1 values in the coordinate vectors and the 0 and 1 values in the transformation matrix may be replaced by different values. Such linear transformations can also be applied to two-dimensional images.

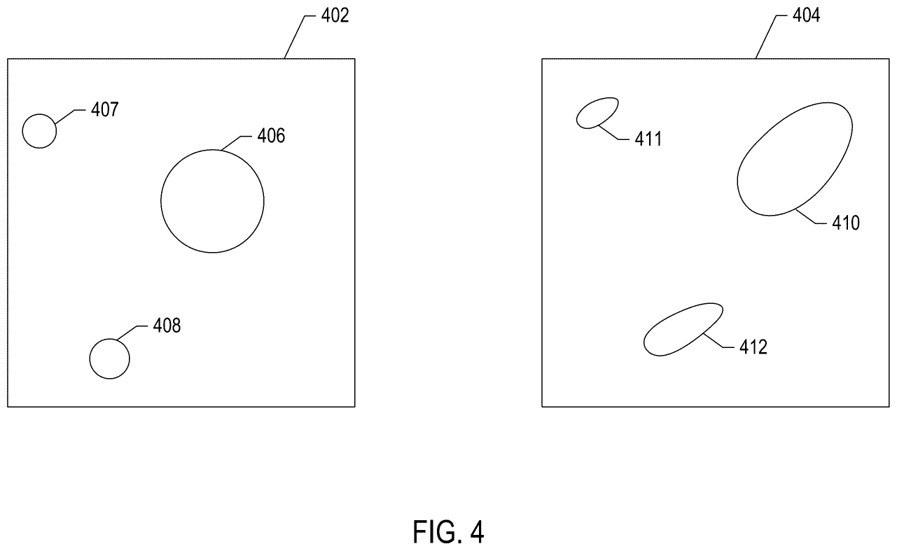

FIG. 4 shows two images with similar features. The first image 402 is identical to the first image in FIG. 1. However, the second image 404 differs significantly from the second image in FIG. 1. A readily apparent difference is that, while the features 406-408 in the first image are circular, the corresponding features 410-412 in the second image are not circular. They are also not elliptical. This is an example of an image-registration problem, the solution of which cannot constitute a linear transformation, such as those discussed above with reference to FIGS. 2 and 3.

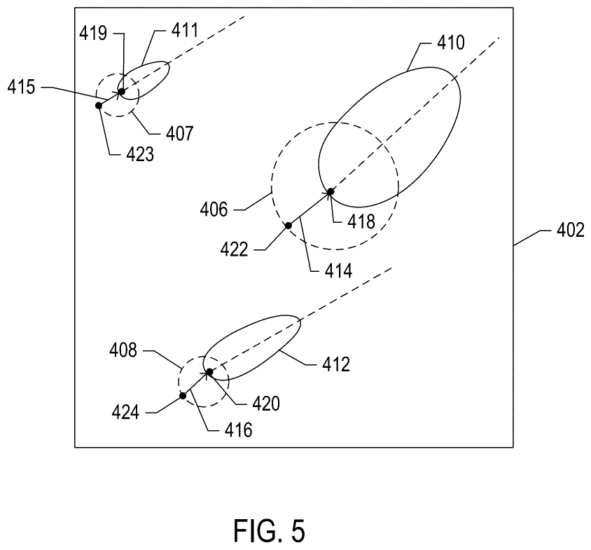

FIG. 5 shows the positions of the three features 410-412 of the second image 404 in FIG. 4 superimposed onto the first image 402. The first-image features 406-408 are shown with dashed borders to distinguish them from the second-image features 410-412. Arrows 414-416 represent displacements of second-image points 418-420 from corresponding first-image points 422-424. Note that the magnitudes and directions of these three displacement vectors all differ from one another. Thus, there is no single linear transformation matrix that can be used as a transform for registering these two images. The translations of points appear to be position-dependent. Furthermore, the transformations produced by linear-transformation matrices cannot generally change circular features into the shapes of the second-image features 410-412. In medical images, the non-rigidly-transformable changes between the two images shown in FIG. 4 are common due to the differential, fluid-like changes in living tissue. For this reason, deformable image-registration methods and systems are generally required for registering two or more medical images to a common reference image.

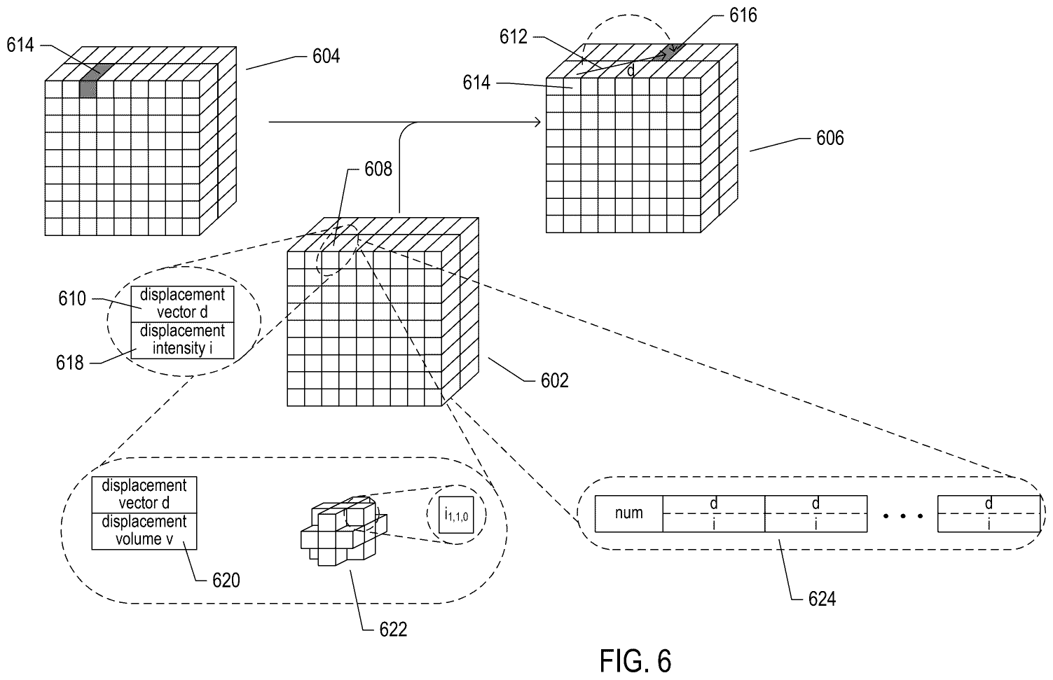

FIG. 6 illustrates different types of deformable-image-registration transforms. A deformable-image-registration transform is a map 602 that maps voxels in a first image 604 to voxels in a second image 606. There are a variety of different ways to do this. Each cell of the map, such as cell 608, may contain a displacement vector 610, shown as arrow 612 indicating displacement of voxel 614 to voxel 616. In the most common type of deformable image-registration transform, each cell in the map contains a single displacement vector. However, in other types of deformable image-registration transforms, each cell may include, in addition to the displacement vector, a displacement intensity or intensity fraction 618 indicating the relative intensity of the displaced voxel in the second image with respect to the intensity of the voxel in the first image. In yet another type of deformable image-registration transform, each cell in the map may include indication of a type of displacement volume 620, where the displacement volume is a volume of voxels 622 each associated with a relative intensity. This allows the intensity of the voxel in the first image to be spread across multiple voxels in the second image. Yet another type of deformable image-registration transform includes an array of displacement-vector/relative-intensity pairs 624, providing for arbitrary mapping of a single voxel in the first image to multiple voxels in the second image. The first above-mentioned deformable image-registration transform is most commonly used since the alternative transforms mentioned above include far more degrees of freedom and thus higher computational costs and far more possible alternative maps that produce similar transform-quality metric values, vastly decreasing the certainty of identifying a correct or most likely transform reflecting a physically meaningful interpretation of the images. As discussed above, because deformable image-registration transformation is not unique and is associated with high computational costs, current deformable image-registration methods often do not produce adequate results. The transformations may produce artifacts and physically unlikely or impossible distortions, as one example. The greater the number of degrees of freedom associated with generation of a transform, the less likely that the transform will correspond to reality. Thus, an improved deformable image-registration transform is needed.

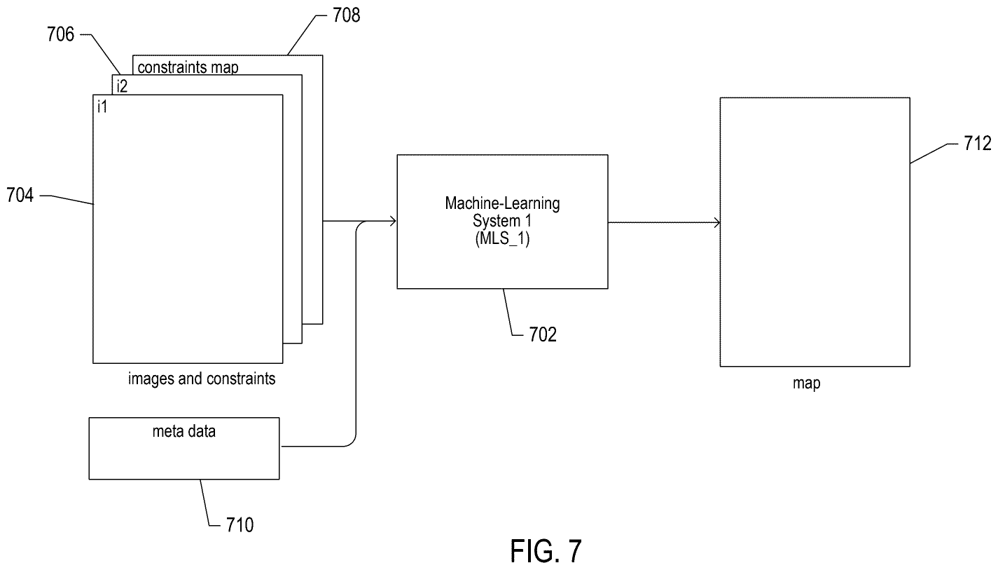

FIG. 7 illustrates a machine-learning system, MLS_1, used in a described implementation of the currently disclosed improved deformable image-registration methods and systems. The machine-learning system MLS_1 702 can be implemented in a variety of different ways, including as a neural-network, convolutional neural-network, and machine-learning transformer. MLS_1 receives, as input, two images i1 704 and i2 706, a constraints map 708, and metadata 710 and outputs a corresponding map or transform 712 representing the results of registering image i2 with image i1. Of course, the two images may be pixelated two-dimensional images, voxelated three-dimensional images, or even higher-dimensional images, with the constraints map and output map having a corresponding dimensionality. The metadata 710 describes various characteristics of the two images, such as the types of images, image-acquisition parameters, portions of the patient for which the images are generated, and other such information. The constraints map 708 is a map or transform that includes displacement vectors for anatomical features identified in both image i1 and images i2. These constraints are fixed and correspond to anatomical features that can be recognized in both images by a different machine-learning system, discussed below. Thus, the currently disclosed deformable image-registration methods are constrained to include transform components corresponding to anatomical features. These constraints significantly decrease the degrees of freedom associated with the overall image-registration process and thus represent a significant improvement to currently available deformable-image-registration methods and systems.

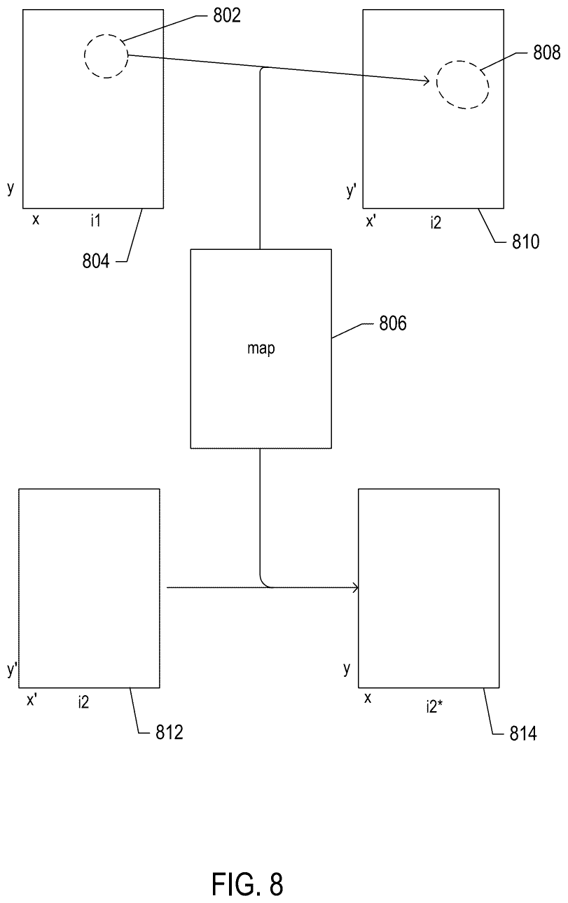

FIG. 8 illustrates example uses of the map generated by the currently disclosed deformable image-registration methods. When a feature and feature position 802 are known or recognized in a first image 804, the map 806 can be used to identify that feature 808 in a second image 810. As another example, the second image 812 can be transformed to the coordinate system of the first image 814 to facilitate comparison of the two images.

In general, the currently disclosed image-registration process assumes that the two images that are to be registered are acquired from the same, or nearly the same, area or volume of a patient and that the two images have been preprocessed by carrying out a best possible rigid-image-registration process to align them with respect to differences arising from differing image-acquisition angles, differences in acquisition parameters, and other such differences that can be corrected, at least in part, by rigid image registration.

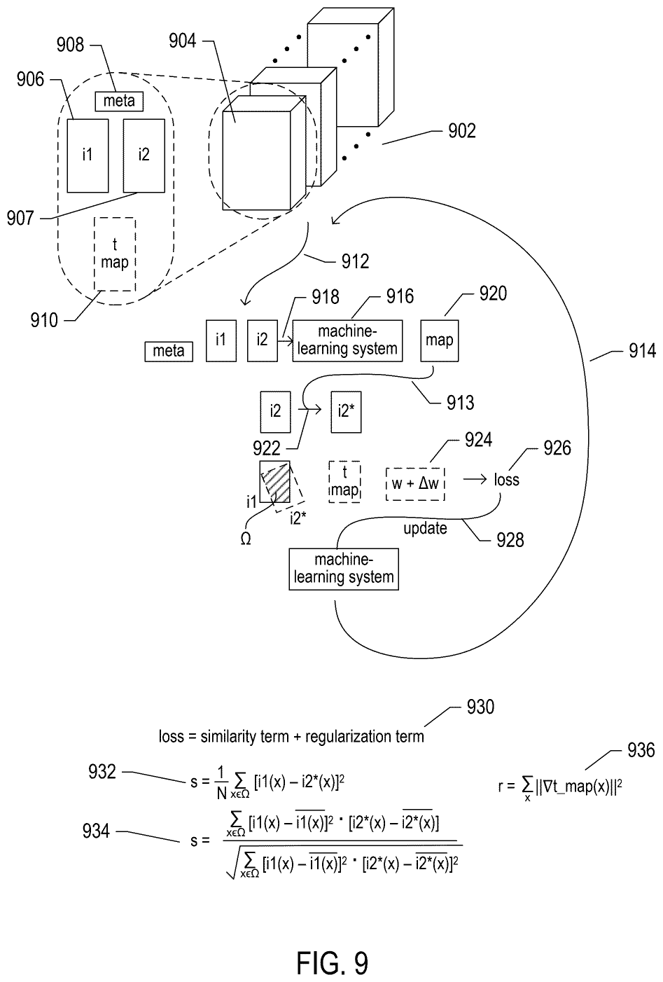

FIG. 9 illustrates training of the machine-learning system MLS_1 shown in FIG. 7. An important component of the training process is a set of training data 902. Each training-data component, such as training-data component 904, includes a pair of images 906-907 and associated metadata 908. In the case of supervised training, the training-data component includes a training transform or map 910 representing a previously determined correct or best transform for registration of the two images. For unsupervised learning, some type of transform-quality metric may be generated for use in training the machine-learning system. In the training process, each training-data component is processed by the machine-learning system in an iterative loop indicated by arrows 912-914. During each loop iteration, a next training-data component or subset of training components is selected, as indicated by arrow 912. The two images and the metadata of the selected training-data component or components are input to machine-learning system MLS_1 916, as indicated by arrow 918, and, in response to this input, machine-learning system MLS_1 outputs a map or transform 920. The output map or transform, as indicated by arrow 913, can then be used to register the second image, as indicated by arrow 922. The common region or regions of both images are then used, along with the transform or map 910 included in the training-data component for supervised learning and projected new weights 924 of machine-learning system MLS_1, in certain implementations, to compute a loss 926 which is back-propagated into machine-learning system MLS_1, as indicated by arrow 928. The iterative loop continues until all of the training-data components have been processed. In general, the computed loss includes a similarity term and a regularization term, as indicated by expression 930. Example similarity terms include a sum of the squared differences between the common portions of the registered images 932 or a correlation coefficient computed from the common portions of the registered images 934. An example of a regularization term 936 is the sum of the magnitudes of the gradient computed for each pixel or voxel in the output transformer or map.

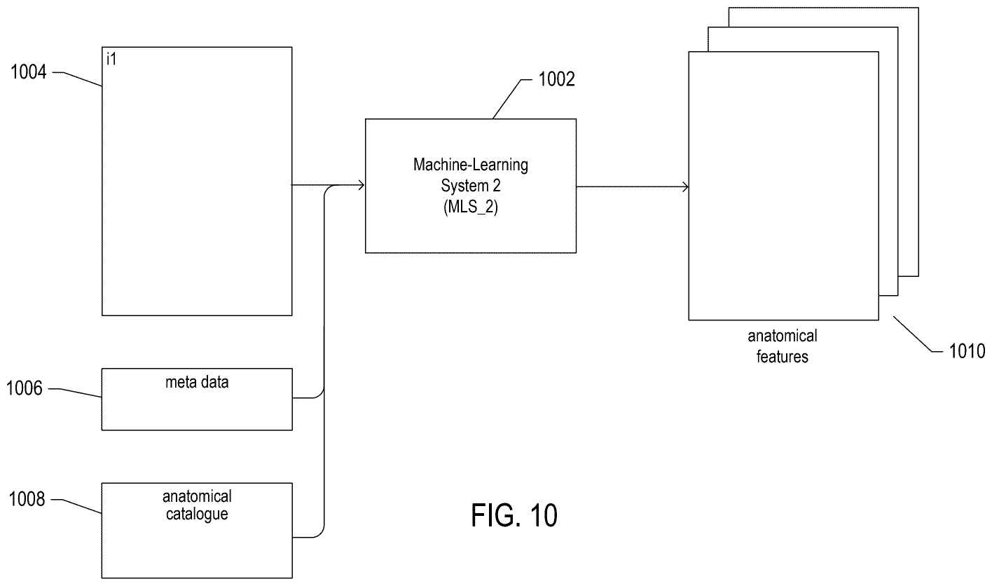

FIG. 10 illustrates a second machine-learning system, MLS_2, employed in the currently discussed implementation of the currently disclosed deformable image-registration methods and systems. The second machine-learning system MLS_2 1002 receives, as input, a medical image 1004, metadata associated with the image 1006, and all or a portion of an anatomical catalog 1008 and outputs a set of anatomical features 1010 present in the image. Each anatomical image is represented by a map that indicates the pixels or voxels that together comprise a recognized anatomical feature. Machine-learning system MLS_2 may be implemented by any of various different machine-learning approaches, including a neural network, convolutional neural-network, transformer, or any of many additional types of machine-learning systems. Machine-learning system MLS_2 is trained in a fashion similar to the training of machine-learning system MLS_1, discussed above with reference to FIG. 7. The set of anatomical features may be ordered according to a confidence metric, with the confidence decreasing from the first to last feature. Alternatively, a separate confidence metric may be output in association with each anatomical feature. In certain implementations, the anatomical features may be represented by surfaces or in ways other than as a set of pixels or voxels.

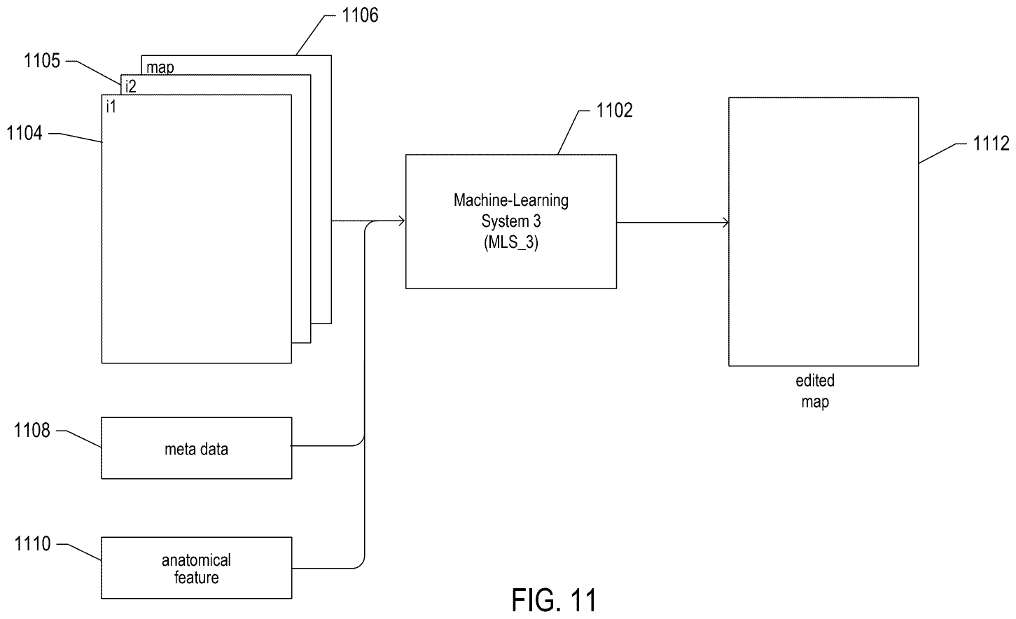

FIG. 11 illustrates a third machine-learning system, MLS_3, employed in the currently discussed implementation of the currently disclosed deformable image-registration methods and systems. The third machine-learning system MLS_3 1102 receives, as input, a pair of medical images 1104-1105, a map or transform 1106 that may include entries related to previously mapped anatomical features, metadata associated with the pair of images 1108, and an anatomical feature 1110 selected from the set of anatomical features produced by the second machine-learning system, as discussed above with reference to FIG. 10. The third machine-learning system MLS_3 outputs a transform or map 1112 that is updated with displacement vectors and other information that map the anatomical feature, represented by the anatomical-feature input 1110, identified in image i1 to the corresponding anatomical feature identified in image i2. The input map 1106 may include previously updated cells for previously considered anatomical features. The third machine-learning system, MLS_3, thus adds additional anatomical-feature constraints to the input map 1106. Alternative implementations may use more complex, non-iterative approaches to selecting anatomical landmarks.

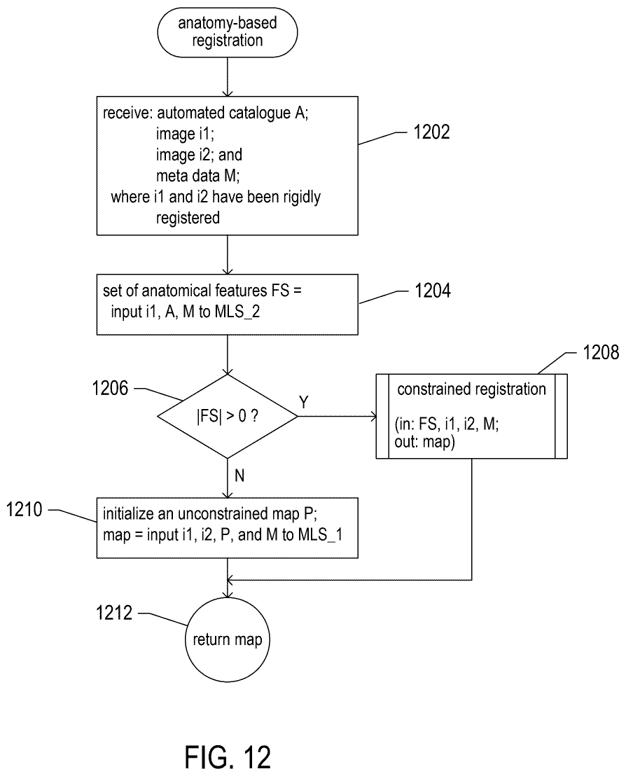

FIG. 12 provides a control-flow diagram that illustrates one implementation of the currently disclosed deformable image-registration process. In step 1202, the routine “anatomy-based registration” receives: (1) an anatomical catalog, or portion of an anatomical catalog, A; (2) a first image, i1; (3) a second image, i2, that is to be registered to the first image; and (4) metadata associated with the first and second images, M. The two images have been preprocessed via a linear image-registration process in order that they conform to one another as closely as possible under a linear transformation representing one or more of translation and rotation, skew, and projection. In step 1204, the routine “anatomy-based registration” inputs i1, A, and M to MLS_2, which outputs a set of anatomical features FS, as discussed above with reference to FIG. 10. These anatomical features are used as landmarks that constrain the deformable image-registration process. Anatomical features constitute useful landmarks because they are relatively easily identified in images. In many cases, anatomical-feature landmarks are resistant to change or deformation, over time, or change and deform in predictable or expected ways. For example, bones generally change far less than more fluid organ tissue and nipples in breast images tend to retain an easily recognizable form despite deformation. When particular anatomical features are recognized in both images, then the displacement vectors determined to map the anatomical feature from image i1 to image i2, and any additional information contained in the map cells corresponding to the anatomical feature, represent a known deformation or invariant structure to anchor or constrain generation of a full deformable-image-registration map or transform. When MLS_2 returns at least one anatomical feature, as determined in step 1206, a routine “constrained registration” is called, in step 1208, to generate the transform or map representing the product of deformable image registration. Otherwise, in step 1210, an unconstrained map P is initialized and input, along with i1, i2, and M, to MLS_1 to generate a map or transform representing the result of unconstrained deformable image registration. In step 1212, the map produced either by the routine “constrained registration” or in step 1210 is returned.

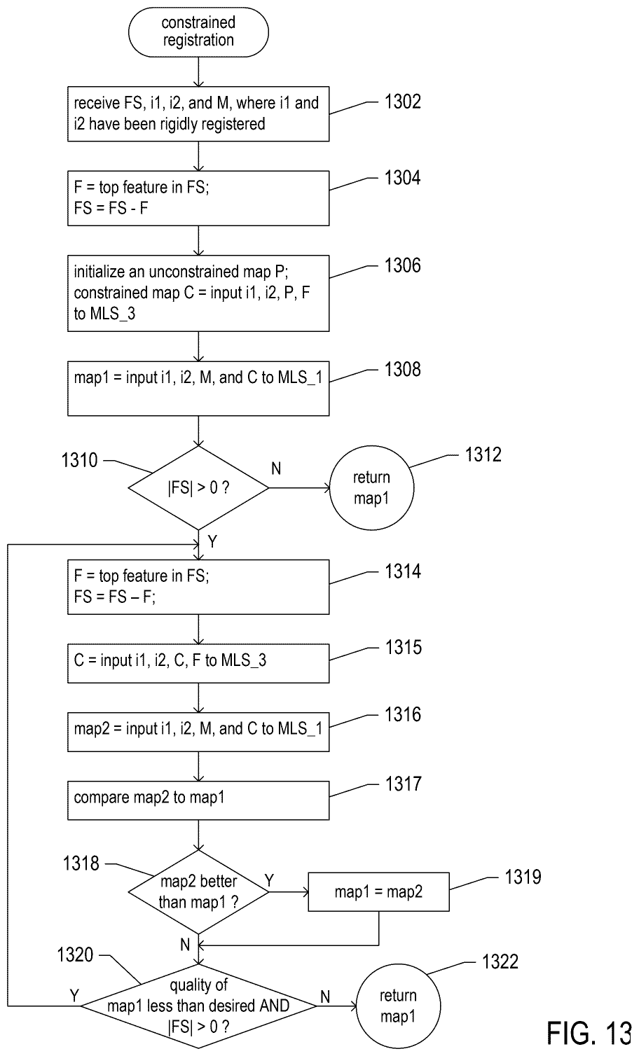

FIG. 13 provides a flow-control diagram for the routine “constrained registration,” called in step 1208 of FIG. 12. In step 1302, the routine “constrained registration” receives a set of anatomical features FS, images i1 and i2, and metadata M associated with the images. In step 1304, local variable F is set to the top feature in FS. The top feature is the feature associated with a highest confidence metric. The feature set FS generated by MLS_2 may be ordered in descending order by confidence-metric value or the confidence-metric values may be generated and used to order FS in a separate step following anatomical-feature generation. The top feature is then removed from FS, also in step 1304. In step 1306, an unconstrained map P is initialized and a constrained map Cis generated by inputting i1, i2, P, and F to MLS_3, as discussed above with reference to FIG. 11. A first map or transform map1 is generated, in step 1308, by inputting i1, i2, M, and C to MLS_1, as discussed above with reference to FIG. 7. When there are no further anatomical features in the set of anatomical features FS, as determined in step 1310, map1 generated in step 1308 is returned, in step 1312. Otherwise, in step 1314, F is set to the top feature in FS and the top feature is removed from FS, in step 1304. In step 1315, local variable C is set to the constrained map obtained by inputting i1, i2, C, and F to MLS_3, as discussed above with reference to FIG. 11. In step 1316, a new map or transform map2 is generated by inputting i1, i2, C, and M to MLS_1, as discussed above with reference to FIG. 7. In step 1317, map2 is compared to map1, using a comparison method that may include generating and comparing metrics, such as the similarity metrics and regularization metric discussed above with reference to FIG. 9. When the comparison carried out in step 1317 indicates that map2 is better than map1, map1 is set to map2, in step 1319. When the quality of map1 is less than a desired or threshold quality and when there is at least one more anatomical feature in FS, as determined in step 1320, control flows back to step 1314 for another iteration of the loop comprising steps 1314-1320. Otherwise, map1 is returned, in step 1322.

There are many additional reasons for improving current medical-image processing methods. For example, there is a need to manage how a given warping algorithm manipulates regions based on the contents of the regions. There are different underlying physical causes for nonlinear distortions. For example, if the purpose of the warping algorithm is to compare two images of the same patient, taken at different times, in order to identify and characterize changes, image differences might occur because of: (1) external pressure being applied to an anatomical structure; (2) normal structures, such as fat or muscle, changing in volume in a non-pathological way, for example due to gain or loss of muscle or fat; (3) new abnormal tissue being deposited in a region where it did not exist previously, for example due to the appearance of a new tumor; (4) new abnormal tissue being deposited adjacent to a location where abnormal tissue existed previously; and (5) a region changing in character rendering the appearance of the region in a subsequent image different from the appearance exhibited by the region in a previous image, such as a region of tissue becoming edematous. In some of these situations, use of a warping method to map one whole region to another whole region, for example, mapping a region of fat in image A to the same region of fat in image B, may be reasonable, even though the volume of the region in image B is different from the volume of the region in image A. In other situations, use of a warping method may not be reasonable. For example, a small region of edematous white matter in image A may not be reasonably warped to an overlapping large region of edematous white matter in image B when the two regions do, in fact, represent different underlying structures, even though they look the same in terms of their image properties and presumptive constitution. Furthermore, the purpose of the warping operation should be taken into consideration. If the purpose of the warping algorithm is to identify regions of abnormal change, such as separating regions of abnormal change from regions of normal change, then warping image A to look just like image B may often fail to accomplish this purpose, because one warping field may embody many different types of change, complicating image interpretation. It might be desirable only to compute the warp field based on normal changes, leaving other regions, including those possibly containing abnormal changes, to be compared using some other mechanism. There is also an issue of confidence in correspondence. In normal structures, it is much easier to confidently establish same-point-to-same-point correspondences, or equivalent-point-to-equivalent-point correspondences. In abnormal structures, establishing such correspondences can be much more difficult. Particularly when considering pathology, structures can change character in ways that render their constitution and imaging appearance quite different, but there can also be the deposition of new tissue, and the distinction between these two situations can be quite ambiguous. In some situations, it can be beneficial to leave the comparison of such ambiguous regions, and detection and characterization of changes if present, to methods other than non-linear registration.

Although the present invention has been described in terms of particular embodiments, it is not intended that the invention be limited to these embodiments. Modifications within the spirit of the invention will be apparent to those skilled in the art. For example, any of many different design and implementation parameters may be varied to produce alternative implementations of the currently disclosed methods and systems, including choice of operating system and virtualization, programming language, hardware platform, modular organization, control structures, data structures, and other such parameters. An important feature of the currently disclosed methods and systems is the use of anatomical features as constraints for machine-learning-based deformable image registration. In the above-described implementation, three different machine-learning systems are used. In alternative implementations, the various tasks carried out in the currently disclosed deformable-image-registration methods and processes may be alternatively partitioned among a different number of machine-learning systems. Machine-learning systems are used for identifying anatomical features in a reference image, generating constraints for deformable image registration by identifying and registering anatomical features in both the reference image and in an image to be registered to the reference image, and generating a map or transform representing a deformable image registration constrained by the anatomical-feature constraints. In alternative implementations, certain of these tasks may be all, or in part, carried out by automated routines or hybrid automated/manual routines or processes. While a pair of images is registered in the currently disclosed implementation, the currently disclosed implementation can be enhanced to register three or more images.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An improved deformable image-registration system that registers a second image to a first image, the improved deformable image-registration system comprising:
an anatomical-feature-set-generation machine-learning system that generates a set of anatomical features identified in the first image;
an anatomical-feature-constraint generation machine-learning system that generates or updates a constraint map to include an anatomical-feature constraint based on an input anatomical feature;
a deformable-image-registration machine-learning system that generates a map or transform representing a deformable image registration of the second image to the first image using a constraint map; and
a controller that generates an unconstrained map or transform by deformable-image registration when no anatomical features are generated by the anatomical-feature-set-generation machine-learning system and that generates a constrained map or transform by deformable-image registration when at least one anatomical feature is generated by the anatomical-feature-set-generation machine-learning system.
